(19) United States
(12) Patent Application Publication
(10) Pub. No.: US 2017/0101922 A1
(43) Pub. Date: Apr. 13, 2017

(54) PRECHAMBER INSERT FOR AN INTERNAL COMBUSTION ENGINE

(71) Applicant: Caterpillar Inc., Peoria, IL (US)

(72) Inventors: Andrew Loetz, West Lafayette, IN (US); Yongxian Gu, West Lafayette, IN (US)

(73) Assignee: Caterpillar Inc., Peoria, IL (US)

(21) Appl. No.: 14/877,183

(22) Filed: Oct. 7, 2015

(51) Int. Cl. F02B 19/08; F02P 13/00

(52) U.S. Cl. CPC F02B 19/08; F02P 13/00

(57) ABSTRACT

In an aspect of the present disclosure, an internal combustion engine is disclosed. The internal combustion engine has a main combustion chamber, a prechamber, an insert in the prechamber, a fuel valve, and an ignition plug. The main combustion chamber is in fluid communication with the prechamber. The prechamber defines an upper volume and a lower volume about a central plane passing through a midpoint of the prechamber. The fuel valve is disposed in the upper volume and is configured to introduce charge into the prechamber. The ignition plug is configured to ignite the charge. The insert is disposed at least partially in the upper volume of the prechamber to promote mixing of the charge.

### TECHNICAL FIELD

The present disclosure relates to an internal combustion engine. In particular, the present disclosure relates to an insert for a prechamber to promote increased turbulence of the charge within the prechamber.

### BACKGROUND

Internal combustion engines often emit harmful oxides of nitrogen (“NOₓ”) during operation. These oxides form when nitrogen and oxygen, both of which are present in the air used for combustion, combine within the main combustion chambers. Typically, the level of NOₓ formed increases as the peak combustion temperatures within the combustion chambers increase. As such, minimizing the peak combustion temperatures within the main combustion chambers generally reduces the emission of NOₓ.

For this reason, leaner fuel mixtures are used for reducing the peak combustion temperatures in the main combustion chamber, thus reducing the amount of harmful NOₓ emitted. A lean fuel mixture has a relatively large air-to-fuel ratio when compared to a stoichiometric air-to-fuel ratio. Accordingly, using more air in the fuel mixture may advantageously lower NOₓ emissions.

Further, most internal combustion engines use an ignition plug to ignite the fuel/air-fuel mixture periodically in the engine cycle. However, as the size of the combustion chamber increases, the effectiveness of ignition plugs to induce combustion is diminished. This is due in part because the arc generated by the ignition plug is localized. The situation is exacerbated when the air/fuel ratio is made lean in an effort to reduce emissions and increase fuel efficiency. In a large combustion chamber, for example, it may take an undesirable period of time for the combustion process to propagate throughout the combustion chamber. Furthermore, using a lean air-to-fuel ratio may result in incomplete combustion i.e. lean misfire within the main combustion chamber. Moreover, turbulence within the main combustion chamber may extinguish the ignition flame before the lean air-fuel mixture combusts. Lean misfire in the engine causes reduced power output and an increase in the amount of un-combusted fuel. In some cases extinguishing of the ignition flame leads to the engine coming to a halt.

To minimize the occurrence of incomplete combustion, some internal combustion engines incorporate a pre-combustion chamber, or prechamber. Either enriched or non-enriched fuel may be advanced in these prechambers. Ignition of the fuel within the prechamber creates a jet of burning fuel that is directed into the main combustion chamber, thus igniting the lean air-fuel mixture within the main combustion chamber. However, a jet flame formed from a heterogeneous mixture in the prechamber may not be sufficient to cause complete combustion of the lean air-fuel mixture within the main combustion chamber.

GB Patent No. 773,278 discloses an internal combustion engine having a prechamber. The prechamber has an insert disposed at the outlet to the main combustion chamber and incorporates a deflector that is adapted to deflect outwardly on to the inner wall of the prechamber air admitted through its bores.

### SUMMARY OF THE INVENTION

In an aspect of the present disclosure, an internal combustion engine is disclosed. The internal combustion engine has a main combustion chamber, a prechamber, an insert in the prechamber, a fuel valve, and an ignition plug. The main combustion chamber is in fluid communication with the prechamber. The prechamber defines an upper volume and a lower volume about a central plane passing through a midpoint of the prechamber. The fuel valve is disposed in the upper volume and is configured to introduce charge into the prechamber. The ignition plug is configured to ignite the charge. The insert is disposed at least partially in the upper volume of the prechamber to promote mixing of the charge.

In another aspect of the present disclosure, an internal combustion engine is disclosed. The internal combustion engine has a main combustion chamber, a prechamber, an insert in the prechamber, a fuel valve, an ignition plug, and a communication passage. The communication passage fluidly connects the main combustion chamber to the prechamber. The communication passage is located below a central plane passing through a midpoint of the prechamber. The fuel valve is disposed above the central plane and is configured to introduce a charge into the prechamber. The ignition plug is configured to ignite the charge. The insert is disposed around or above the central plane to promote mixing of the charge.

In yet another aspect of the present disclosure, a method of igniting a charge in an internal combustion engine is disclosed. The internal combustion engine has a main combustion chamber that is in fluid communication with a prechamber. The prechamber defines an upper volume and a lower volume about a plane passing through a midpoint of the prechamber. The method includes introducing a charge in the upper volume, passing the charge through an insert in the upper volume to promote mixing of the charge and igniting the charge to form a jet flame directed into the main combustion chamber.

### BRIEF DESCRIPTION OF THE DRAWINGS

FIG. 1 illustrates a cross-sectional view of an internal combustion engine according to an embodiment of the present invention, in which an insert is placed on the central plane of the prechamber and an ignition plug is placed in the lower volume.

FIG. 2 illustrates a cross-sectional view of an internal combustion engine according to an alternate embodiment of the present invention, in which an insert is placed in the upper volume of the prechamber and an ignition plug is placed in the lower volume.

FIG. 3 illustrates a cross-sectional view of an internal combustion engine according to yet another embodiment of the present invention in which the insert is disposed at the midpoint of the prechamber and the ignition plug is disposed in the upper volume of the prechamber.

FIG. 4 illustrates a cross-sectional view of an internal combustion engine according to yet another embodiment of the present invention in which half of the insert lies in the upper volume of the prechamber.

FIG. 5 illustrates a perspective view of the insert disposed in the prechamber in accordance with an embodiment of the present invention.

FIG. 6 depicts a method of reforming fuel within a prechamber according to an embodiment of the present invention.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

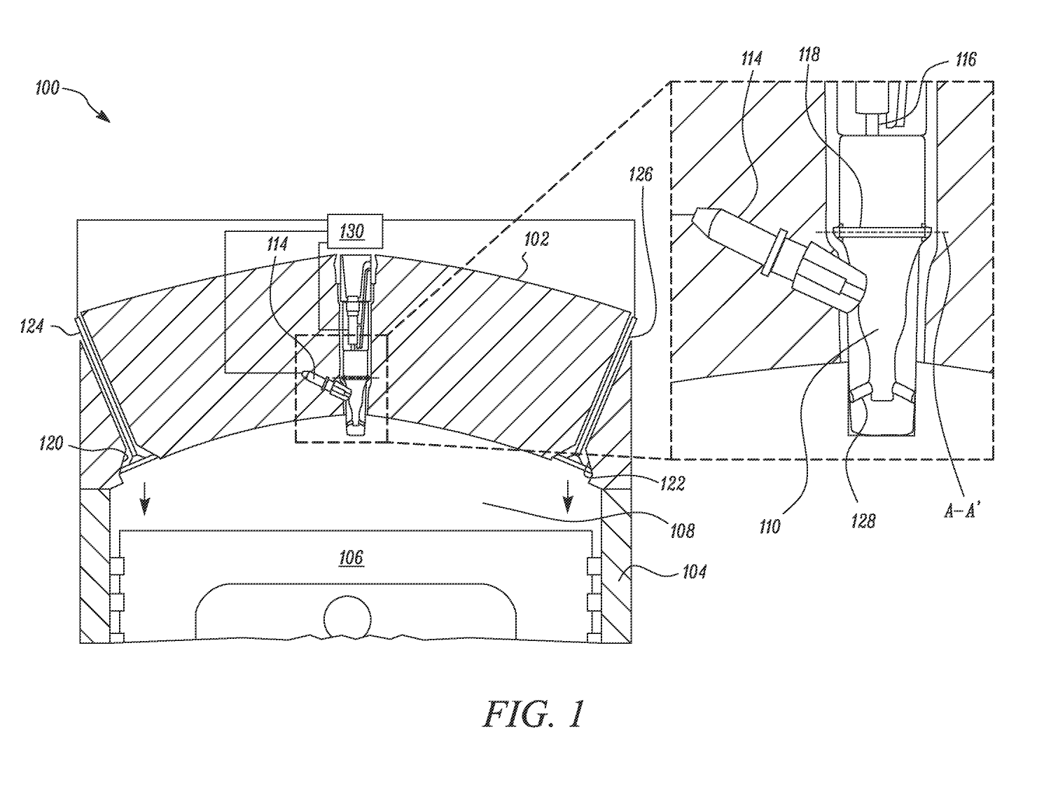

The present disclosure relates to an internal combustion engine for improving the combustion process and avoiding misfire. FIG. 1 illustrates an exemplary engine 100 configured to power a vehicle. In the exemplary embodiment, the engine 100 may be an internal combustion engine for a ground engaging machine. In various other embodiments, the engine 100 may be any engine running on solid, liquid or gaseous fuel, used for various purposes such as an automobile, a construction machine, any transportation vehicle and the like.

Referring to FIG. 1, a first embodiment of an internal combustion engine 100 includes a cylinder head 102 and a cylinder block 104. The cylinder head 102, the cylinder block 104 and a piston 106 form a main combustion chamber 108. The main combustion chamber 108 is configured to receive fuel/air-fuel mixture i.e. charge. The charge is burnt and the piston 106 is configured to transmit the driving force created by the burning charge to an output shaft (not shown).

The main combustion chamber 108 is in fluid communication with a prechamber 110. The prechamber 110 has a capacity that is smaller than that of the main combustion chamber 108. The prechamber 110 is configured to receive either enriched or non-enriched charge. Ignition of the charge within the prechamber 110 creates a jet of burning charge that is directed into the main combustion chamber 108, thus igniting the lean charge within the main combustion chamber 108. In an embodiment, the prechamber 110 may be of spherical shape to promote swirl inside the prechamber 110. As one of skill in the art will appreciate, the prechamber 110 may be of any other type or shape known in the art. In the embodiment illustrated, the prechamber 110 is disposed at substantially a central portion of the main combustion chamber 108. In various other embodiments, the prechamber 110 may be connected with the main combustion chamber 108 at other locations.

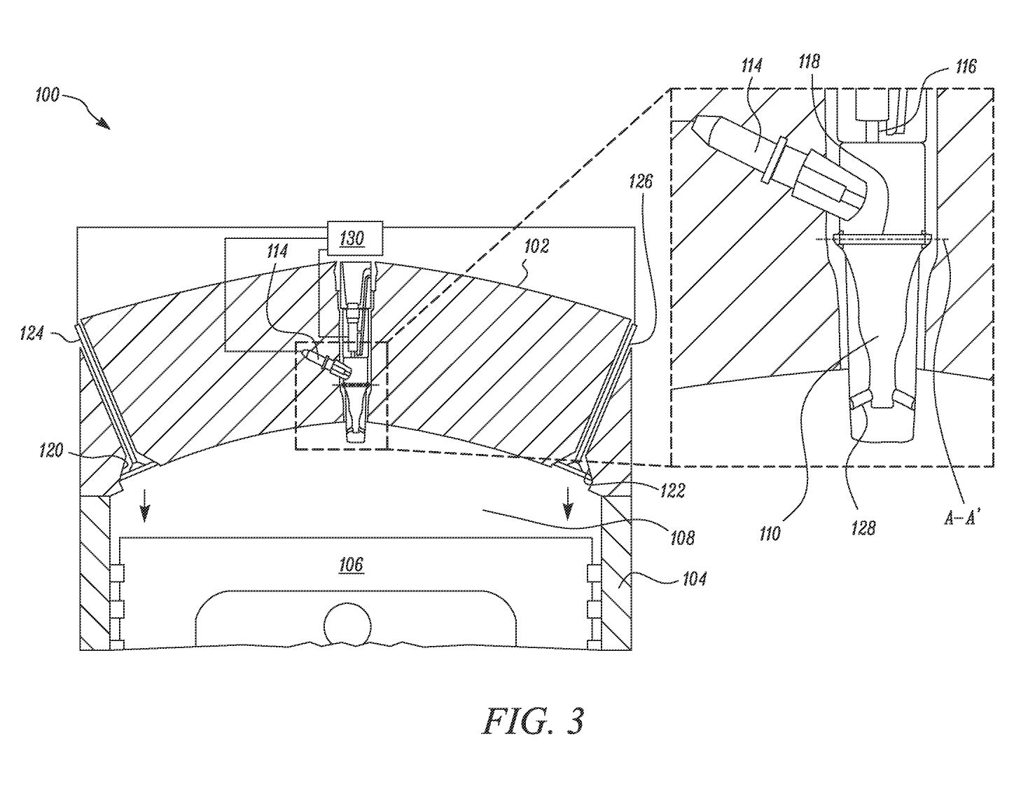

The prechamber 110 defines an upper volume and a lower volume about a central plane A-A′ passing through a midpoint of the prechamber 110. An ignition plug 114 is disposed in the lower volume of the prechamber 110 as shown in FIG. 1. In an alternate embodiment, the ignition plug 114 may be disposed in the upper volume of the prechamber 110 as shown in FIG. 3. The ignition plug 114 is configured to ignite the charge present in the prechamber 110. The ignition plug 114 may be connected with the prechamber 110 by welding or other methods known in the art. In an alternate embodiments, the ignition plug 114 may at any other location in the prechamber 110. The ignition plug 114 may be a typical J-gap spark plug, rail plug, extended electrode, or laser plug or any other type of spark plug known in the art.

A fuel valve 116 is disposed in the upper volume of the prechamber 110. The fuel valve 116 is configured to introduce a fuel or charge into the prechamber 110. The fuel valve 116 may be connected with the prechamber 110 by welding or other methods known in the art. In an alternate embodiment, the fuel valve 116 may be disposed at the top of the prechamber 110. In various other embodiments the fuel valve 116 may be disposed at other locations in the upper volume of the prechamber 110. The fuel valve 116 may be any type of charge introducing means known in the art.

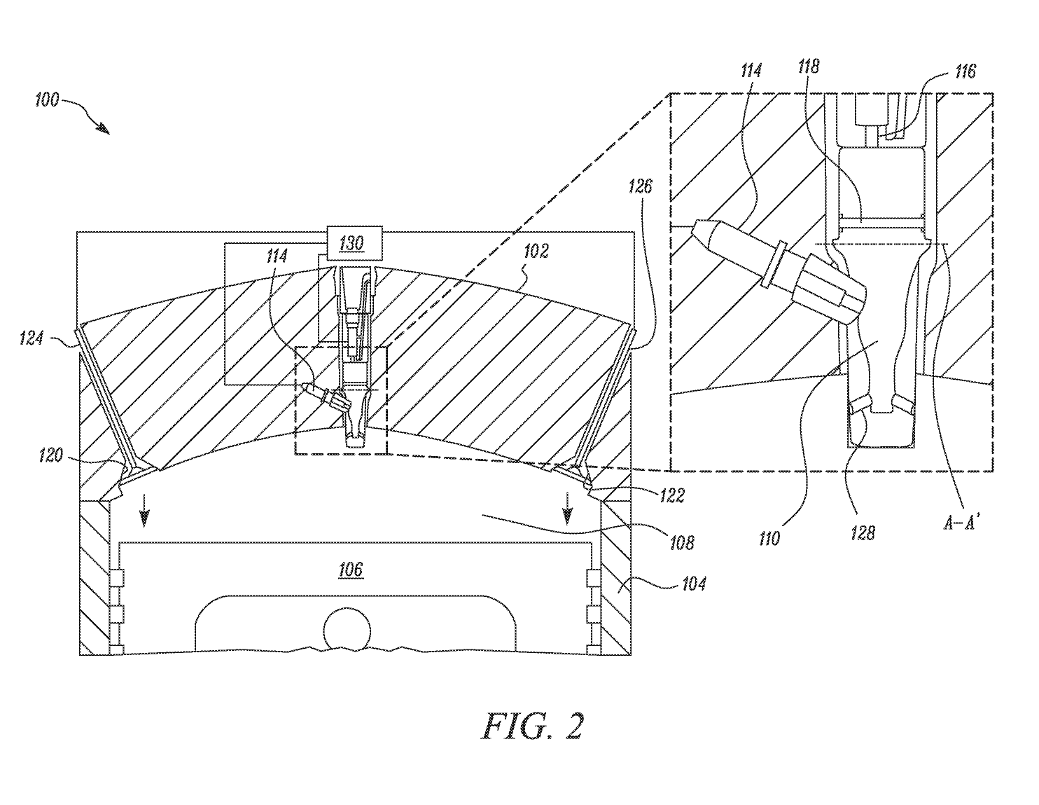

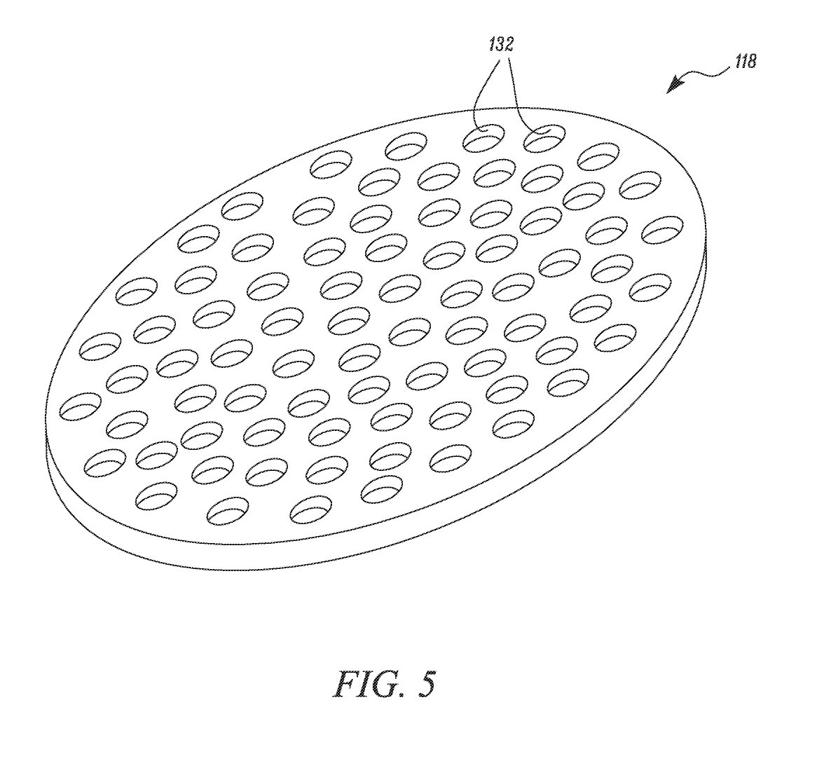

An insert 118 is disposed within the prechamber 110. The insert 118 is positioned in the upper volume of the prechamber 110 substantially parallel to the central plane A-A′ dividing the prechamber 110 into upper and lower volume as shown in FIG. 2. The insert 118 is configured to create turbulence in the charge entering the prechamber 110. The turbulence provides for mixing of the charge around the insert 118. The insert 118 may have slots 132 as shown in FIG. 5. In the embodiment illustrated the insert 118 is a perforated plate. In various other embodiments, the insert 118 may be a sieved structure or any other structure to provide mixing of the charge and breaking down of larger molecules flowing from the upper volume to the lower volume.

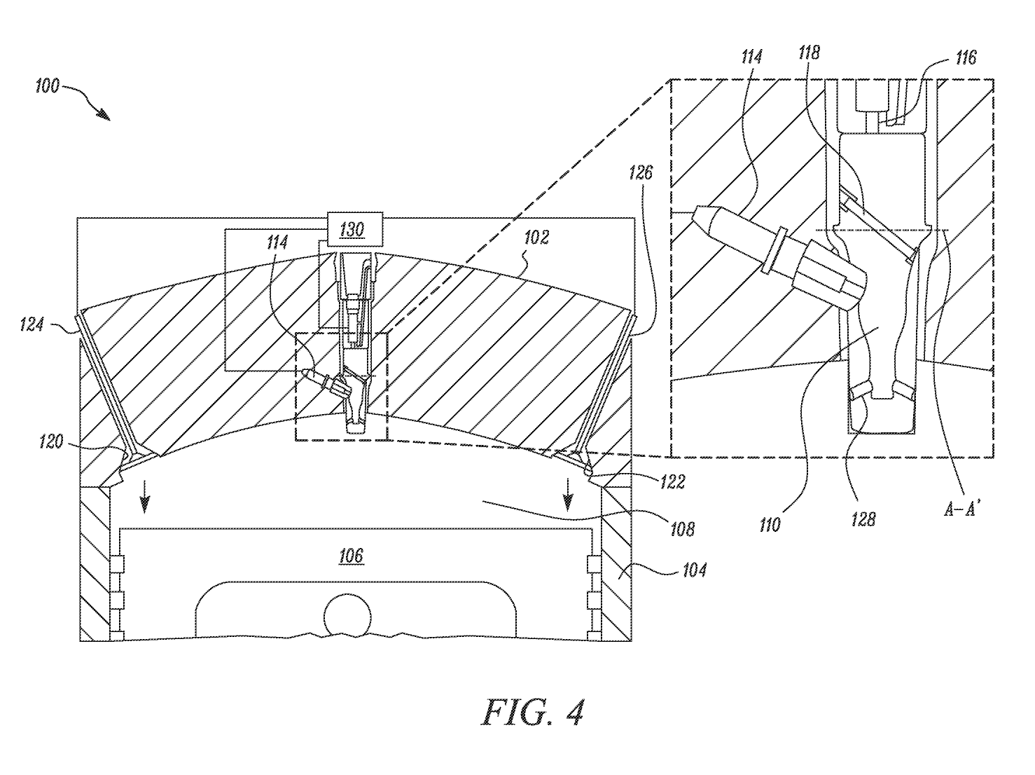

In an alternate embodiment, the insert 118 may be inclined to the central plane A-A′ which divides the prechamber into the upper and the lower volume as shown in FIG. 4. In the embodiment illustrated, half of the insert 118 lies above the central plane A-A′ in the upper volume as shown in FIG. 4. In various other embodiments, at least a portion of the insert 118 may lie above the central plane A-A′ in the upper volume of the prechamber 110.

The cylinder head 102 includes an intake port 120 and an exhaust port 122. A charge intake valve 124 is disposed on the intake port 120. The charge intake valve 124 may be driven by an intake cam (not shown) to control the supply of the charge to the main combustion chamber 108. When the charge intake valve 124 is positioned in an open position the intake port 120 is in fluid communication with the main combustion chamber 108. Further, the charge intake valve 124 in the open position facilitates the introduction of charge through the intake port 120 and into the main combustion chamber 108. When the charge intake valve 124 is in a closed position, the intake port 120 is isolated from the main combustion chamber 108 thereby preventing charge from entering the main combustion chamber 108 via intake port 120.

An exhaust valve 126 may be disposed on the exhaust port 122. The exhaust valve 126 may be driven by an exhaust cam (not shown) to control the discharge of the combustion products from the main combustion chamber 108. When the exhaust valve 126 is in an open position, the exhaust port 122 is in fluid communication with the main combustion chamber 108. Further, the exhaust valve 126 in the open position allows the exhaust/combusted gases to advance from the main combustion chamber 108 and into the exhaust port 122. When the exhaust valve 126 is in a closed position the exhaust port 122 is isolated from the main combustion chamber 108 and prevents charge from exiting the main combustion chamber 108 and into the exhaust port 122.

The prechamber 110 is in fluid communication with the main combustion chamber 108 through a communication passage 128. The charge that is injected from the charge intake valve 124 is supplied to the main combustion chamber 108 as fresh charge, may also be supplied to the prechamber 110 via the communication passage 128.

The engine 100 has an electronic control unit (ECU) 130. The electronic control unit ECU 130 may be a digital computer that may include a central processing unit (CPU), a read-only-memory (ROM), a random access memory (RAM), and an output interface. The ECU 130 receives input signals from various sensors (not illustrated) that represent various engine operating conditions. For example, an accelerator opening signal from an accelerator opening sensor may detect engine load, a water temperature signal from a water temperature sensor may detect engine temperature, and a crank angle signal from a crank angle sensor may detect the angular position of a crankshaft (not shown), and which may be used by the ECU 130 to calculate engine rotation speed (e.g., number of revolutions per minute of the engine 100). In response to the input signals, the ECU 130 controls various parameters that govern operation of the engine 100. For example, the ECU 130 may control the amount and timing of the charge injected by the fuel valve 116 and the ignition timing of the ignition plug 114. In accordance with a given operating condition of the engine 100, the ECU 130 controls a phase difference between the ignition timing of the ignition plug 114 (i.e., ignition of the charge in the prechamber 110) and the opening of the fuel valve 116.

The working of the engine 100 along with the ECU 130 will now be explained. The ECU 130 generates an output signal that causes the charge intake valve 124 to open, thereby allowing enriched or non-enriched charge to advance into the main combustion chamber 108. Simultaneously, the ECU 130 generates an output signal that causes the fuel valve 116 to open, thereby allowing charge to advance into the prechamber 110. The charge introduced by the fuel valve 116 passes through the insert 118. When this charge encounters the turbulence around the insert 118 it facilitates mixing of the charge and breaking down of larger molecules thereby creating a homogeneous charge mixture within the prechamber 110. This creates a homogenous mixture of charge around the insert 118 near the ignition plug 114.

As the charge moves away from the insert 118, the turbulence in the charge reduces providing for a lesser turbulent but more homogeneous charge near the ignition plug 114. Further, the ECU 130 fires the ignition plug 114 causing ignition of the homogenized charge in the prechamber 110.

The spark from the ignition plug 114 ignites the homogenized charge within the prechamber 110, which causes the flame jet i.e. a front of burning charge through the at least one communication passage 128 and into the main combustion chamber 108. The front of burning charge i.e. the flame jet from the prechamber 110 advances through the at least one communication passage 128 and into the main combustion chamber 108. The flame jet entering main combustion chamber 108 ignites the charge within main combustion chamber 108, thereby driving the piston 106 downward so as to rotate the crankshaft of the engine 100 for producing mechanical output.

### INDUSTRIAL APPLICABILITY

Power producing units such as diesel engines, gasoline engines, and gaseous fuel-powered engines require an optimum amount of fuel/air-fuel mixture to produce high power at a high efficiency. However, these engines often emit harmful oxides of nitrogen (“NOₓ”) during operation. These oxides form when nitrogen and oxygen, both of which are present in the air used for combustion, combine within the main combustion chambers. Since the level of NOₓ formed increases as the peak combustion temperatures within the combustion chambers increase leaner fuel mixtures are used for reducing the peak combustion temperatures in the main combustion chamber, thus reducing the amount of harmful NOₓ emitted. However, a leaner fuel mixture causes lean misfire inside the engine. This misfiring leads to reduced power output and an increase in the amount of un-combusted fuel. In order to maximize the power output generated by the combustion process in the engine and minimize the occurrence of incomplete combustion, some internal combustion engines incorporate a prechamber. Ignition of the fuel within the prechamber creates a jet of burning fuel that is directed into the main combustion chamber, thus igniting the lean air-fuel mixture within the main combustion chamber. However, a jet flame formed from a heterogeneous mixture in the prechamber may not be sufficient to cause complete combustion of the lean air-fuel mixture within the main combustion chamber.

In an aspect of the present disclosure, the prechamber 110 is divided by a central plane A-A′ into upper and lower volume as shown in FIG. 1. The central plane A-A′ passes through the midpoint of the prechamber 110. The ignition plug 114 is disposed in the lower volume of the prechamber 110. The insert 118 is disposed in the upper volume of the prechamber 110 and configured to create turbulence around the insert 118. The ECU 130 is configured to control opening and closing of the fuel valve 116. The ECU 130 is further configured to control the actuation timing of the ignition plug 114.

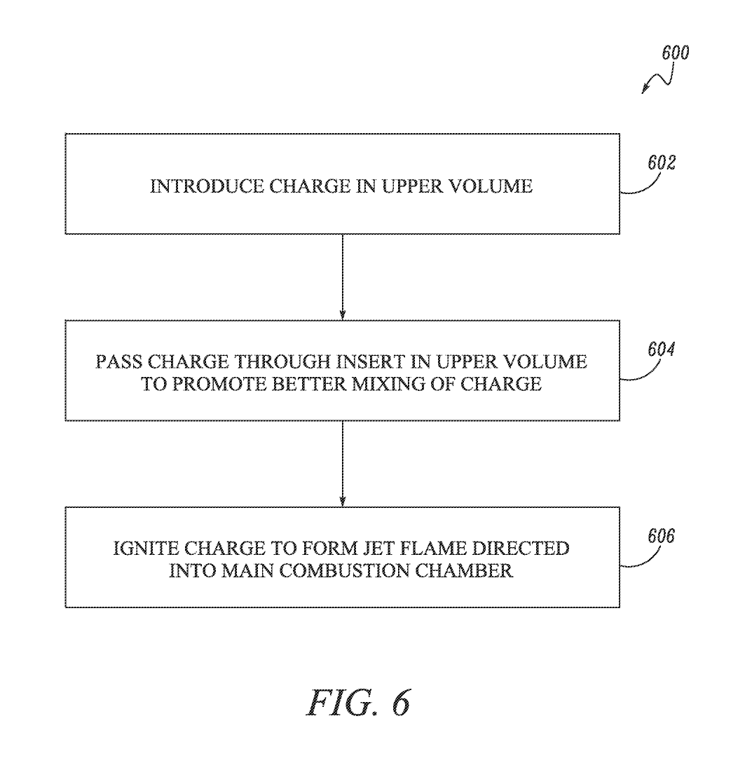

The method 600 of igniting the charge in the engine 100 will now be described in detail with reference to FIG. 6. The ECU 130 generates an output signal to the fuel valve 116 to open and allow the charge to advance into the upper volume of the prechamber 110 (Step 602). The charge that is introduced in the prechamber 110 is passed through the insert 118 (Step 604). On its way through the insert 118 turbulence is created in the charge that homogenizes the charge present in the prechamber 110. This homogenized charge is then passed near the ignition plug 114. The volume near the ignition plug 114 has lesser turbulence than that near the insert 118. The ECU 130 generates an output signal to the ignition plug 114 to create a spark in the prechamber 110. The sparking of the ignition plug 114 ignites the charge within the prechamber 110, which causes the flame jet i.e. a front of burning charge through the communication passage 128 and into the main combustion chamber 108 (Step 606). The flame jet formed from the homogenized charge mixture allows for more robust burning of the charge within the main combustion chamber 108 thereby driving the piston 106 downward to produce mechanical output.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An internal combustion engine comprising:
a main combustion chamber in fluid communication with a prechamber, the prechamber defining an upper volume and a lower volume about a central plane passing through a midpoint of the prechamber;
a fuel valve disposed in the upper volume and configured to introduce a charge into the prechamber;
an ignition plug configured to ignite the charge; and
an insert disposed at least partially in the upper volume of the prechamber to promote mixing of the charge.

2. The internal combustion engine of claim 1, wherein the insert is perforated plate.

3. The internal combustion engine of claim 1, wherein the insert is parallel to the central plane.

4. The internal combustion engine of claim 1, wherein the insert is inclined to the central plane.

5. The internal combustion engine of claim 1, wherein the insert divides the prechamber into the upper volume and the lower volume.

6. The internal combustion engine of claim 1 wherein the entire insert is in the upper volume.

7. The internal combustion engine of claim 1 wherein the insert is proximate the fuel valve.

8. The internal combustion engine of claim 1 wherein the ignition plug is in the upper volume.

9. The internal combustion engine of claim 1 wherein the ignition plug is in the lower volume.

10. An internal combustion engine comprising:
a main combustion chamber in fluid communication with a prechamber;
a communication passage to fluidly connect the main combustion chamber to the prechamber, the communication passage located below a central plane passing through a midpoint of the prechamber;
a fuel valve disposed above the central plane and configured to introduce a charge into the prechamber;
an ignition plug configured to ignite the charge; and
an insert disposed around or above the central plane to promote mixing of the charge.

11. The internal combustion engine of claim 10, wherein the insert is perforated plate.

12. The internal combustion engine of claim 10, wherein the insert is parallel to the central plane.

13. The internal combustion engine of claim 10, wherein the insert is inclined to the central plane.

14. The internal combustion engine of claim 10, wherein the insert divides the prechamber into the upper volume and the lower volume.

15. The internal combustion engine of claim 10 wherein the entire insert is in the upper volume.

16. The internal combustion engine of claim 10 wherein the insert is proximate the fuel valve.

17. A method of igniting a charge in an internal combustion engine, the internal combustion engine having a main combustion chamber in fluid communication with a prechamber, the prechamber defining an upper volume and a lower volume about a central plane passing through a midpoint of the prechamber; the method comprising:
introducing a charge in the upper volume;
passing the charge through an insert in the upper volume to promote mixing of the charge; and
igniting the charge to form a jet flame directed into the main combustion chamber.

18. The method of claim 17, further comprising creating turbulence in the charge in the upper volume.

19. The method of claim 17, further comprising igniting the charge in the lower volume.

20. The method of claim 17, further comprising igniting the charge in the lower volume.
